(19) United States
(12) Patent Application Publication
(10) Pub. No.: US 2004/0191394 A1
(43) Pub. Date: Sep. 30, 2004

(54) Soy-based composition useful as supplementary food and a process for preparing the same

(76) Inventors: Sridevi Annapurna Singh, Mysore (IN); Tirumakudalu Chikkaraja Sindhu Kanya, Mysore (IN); Purnima Kaul Tiku, Mysore (IN); Bhagya Swamylingappa, Mysore (IN); Appu Rao Gopala Rao Appu Rao, Mysore (IN); Vishweshwariah Prakash, Mysore (IN)

Correspondence Address: Joseph J. Crimaldi, Renner, Otto, Boisselle & Sklar, LLP, Keith Building, 19th Floor, 1621 Euclid Avenue, Cleveland, OH, 44115-2191, US

(21) Appl. No.: 10/402,027

(22) Filed: Mar. 28, 2003

(51) Int. Cl. A21D 2/00

(52) U.S. Cl. 426/622; 426/629

(57) ABSTRACT

The present invention provides a nutritious soy-based composition useful as supplementary food, the composition comprising about 41 to about 53% by dry weight wheat, about 5 to about 20% by dry weight malted Jowar flour, about 10 to about 20% by dry weight de-fatted soy flour, about 5 to about 10% by dry weight roasted Bengal gram dhal and about 25 to about 35% sweetener and a process for preparing the nutritious soy-based supplementary food.

### FIELD OF THE INVENTION

The present invention relates to a nutritious soy-based composition useful as supplementary food and a process for preparing the nutritious soy-based composition.

### BACKGROUND OF THE INVENTION

The problem of malnutrition, with all its implications to public health and natural development, is probably the greatest challenge for planners, scientists and administrators in India. Any attempt to meet this challenge must be based on scientific foundations and on a clear appreciation of the practical realities and constraints in the existing situations.

The preschool years are critical for growth and development with more rapid and frequent transitions occurring in dietary patterns than in other age groups. The outstanding nutritional problems in the country that currently account for significant impairment of the country's human resources are protein-energy malnutrition, which leads to physical and mental retardation and the under development of children. The solution to the problem of protein-energy malnutrition could be achieved through proper use of inexpensive traditional cereal-legume-based diets within the economic reach of poor families and within the country's resources.

A hurdle in feeding cereal-legume based diets to very young children starts from the low calorie density of these diets, which could be overcome by the reductin of viscosity of cooked cereal foods, and their calorie density increased by the addition of malted flour, a source of digestive enzymes.

At present, the problem of malnutrition and its implication on the public health and national development is the greatest challenge which is bothering the scientists and administrators in the country (e.g., India).

Efforts are being made by the World Food Programme (WFP) to alleviate hunger and malnutrition by providing nutritious products at affordable prices to governments throughout the world to feed the children and mothers at nutritionally critical times.

India's rural population are subject to three common forms of nutritional deprivation:

(1) inadequacy of food intake among the poorer segment leading to calorie deficiency;

(2) the lack of extra nutritional need of infants and preschool children; and

(3) deficiency of specific micro nutrients, such as Vitamin A and iron. Consequently infant and toddler mortality rates for rural India are very high.

Many nutritious food supplements, such as Indian multipurpose food, Bal-Aahar and corn-soy milk, have been extensively used in various nutrition intervention programs by various agencies. Although blends would provide the requirement of both proteins and calories to preschool and school children, they pose a number of hurdles, in large scale programs, which include ingredient(s) that are raw materials which have to be cooked to be acceptable foods, distribution centers should be equipped with a sanitary kitchen, the need for cooking facilities and high process time.

Keeping these factors in view, an improved process for the preparation of a nutritious soy-based formulation which is useful as supplementary food based on cereal (wheat), Bengal gram dhal, soy dhal (i.e., soya dhal), de-fatted protein rich oilseed meals would be desirable.

The product formulated from such a process is useful as ready-to-use weaning/nutrition food for children and pregnant women.

Reference may be made to U.S. Pat. No. 3,911,142 by Huelskamp et al. (1975), wherein claim is made for a process for a ready-to-eat product which has a high protein content. The product contains soy protein, whey and potato flakes. The product results from a critical sequence of processing steps. The drawback is that the product has potato flakes which necessitate an additional unit operation of flaking and drying. The process has a high protein content of 70% and fat content of 1% which influences the taste of the product.

Reference may be made to U.S. Pat. No. 5,922,386 by Reed et al. (1999), The Procter and Gamble Company, Cincinnati, Ohio, wherein a process is described for the preparation of a reduced fat shaped snack product having a light crispy, crunchy texture using a starch based flour, fat and water. The snack pieces are fried to provide a snack having 20 to 38% fat. The process involves frying as a unit operation, which could lead to short shelf life due to any exposed fat becoming rancid.

Reference may be made to U.S. Pat. No. 5,171,600 by Young et al. (1992), The Procter and Gamble Company, Cincinnati, Ohio, wherein a process is described for the preparation of reduced fat shaped snack product having a light crispy, crunchy texture using a flour such as potato flour (50 to 80%) and water (20 to 50%). Snack pieces are cut, extruded and fried. The excess fat is removed by stripping with superheated steam. This process has a disadvantage of frying and then stripping of the excess fat as it is both energy intensive and expensive. Since the major ingredient is potato, the product is starch based without much protein.

Reference may be made to U.S. Pat. No. 4,421,770 by Wiker et al. (1983), The Kansas State University Research Founation, Manhattan, Kans., wherein a high protein snack food is described which is prepared from egg protein by a process involving heat coagulation of a molded body of the egg protein composition, slicing and coating the slices with a liquid batter-mix containing mainly starch. The batter coagulum slices are breaded and deep fat fried to seal their outer surfaces. The disadvantage of this process is that it involves deep fat frying and any exposed fat becomes rancid, if proper packaging and storage conditions are not provided.

Reference may be made to U.S. Pat. No. 5,554,405 by Fazzolare et al. (1996), Nabisco, Inc., Parsippany, N.J., wherein a baked corn based snack product composed of a blend of masa corn flour and corn flour is disclosed which has a crisp chip like texture and blistered appearance. The ingredients used in the process are different from those used in the present invention.

Reference may be made to U.S. Pat. No. 6,139,884 by Shifferaw et al. (2000) of Sanpablo, Calif., wherein a high energy snack food consisting primarily of an admixture of barley, flax and teff. The ingredients used in the process are different from those used in the present invention.

Reference may be made to U.S. Pat. No. 6,291,009 by Cohen (2001) of Butler, Md., for a method of producing a soy-based dough. The dough has a soy component, a pregelatnized starch component, and optionally other ingredients. The soy component is about 60 to about 90% of the dry ingredients. The ingredients and formulation used in the present invention are different from the above.

Reference may be made to U.S. Pat. No. 6,333,063 Ariga et al. (2001), Kikkoman Corporation and WF POP Co., Ltd., both of Japan, which describes a high protein food of plate form having a protein content of 40% by weight or more. The product is obtained by puffing-molding. In the present invention, the protein content is about 15 to about 17% and the product is made by baking. The ingredients of the present invention also differ.

Reference may be made to U.S. Pat. No. 5,498,438 by Strong et al. (1996), Nabisco, Inc. of Parsippany, N.J., describes a process for the preparation of nut based snack products. The invention is a high protein, low fat, nut based snack product using de-fatted roasted nut meal (about 40% of the total weight of the dough), a starch component and water. The present invention uses whole nuts, like groundnuts, and not de-fatted nut meal. The ingredients and formulation are also different.

### OBJECT OF THE INVENTION

One object of the present invention is to provide a new soy-based nutritious supplementary food that obviates the aforesaid disadvantages.

Another object of the present investigation is to provide an improved process for preparation of nutritious soy-based formulation useful as supplementary food.

Yet another object is to provide a ready to eat food with at least about 12 to about 17%, or even about 12 to about 15% good quality protein.

Still another object is to use protein rich edible soy flour as one of the ingredients incorporating Bengal gram as the flavoring and a nutrient supplement for essential amino acid (e.g., lysine).

Yet another object is to provide a process for ready-to-eat nutritious food with good taste.

Still another object is to obtain a product which is microbiologically safe.

A further object of the present invention is to have new formulation which contains protein rich edible de-fatted soy flour.

Another object of the present invention is to incorporate sugarcane juice concentrate/sucrose in the formulation as a caloric provider and taste-maker.

Still another object of the present invention is to incorporate an efficient solid-solid mixing operation in order to obtain near homogeneity in the new formulation.

Yet another object of the present invention is to incorporate nutrient mix in the formulation to meet desired nutrient requirements.

One more object of the present invention is to incorporate an efficient and cost effective roasting operation without the drawback of sand contamination of the conventional roasting process.

Another object is to provide a process with minimal processing involved.

Yet another object is to obtain a product which can be easily served.

Still another object is to obtain a product with a shelf life of at least about 6 months.

A further object is to provide a process which can be used for community feeding programs.

### SUMMARY OF THE INVENTION

Accordingly, the present invention provides a nutritious soy-based composition useful as supplementary food, the composition comprising about 41 to about 53% by dry weight wheat, about 5 to about 20% by dry weight malted Jowar flour, about 10 to about 20% by dry weight de-fatted soy flour, about 5 to about 10% by dry weight roasted Bengal gram dhal and about 25 to about 35% sweetener and a process for preparing the nutritious soy-based supplementary food.

To the accomplishment of the foregoing and related ends, the invention, then, comprises the features hereinafter fully described and particularly pointed out in the claims. These embodiments are indicative, however, of but a few of the various ways in which the principles of the invention may be employed. Other objects, advantages and features of the invention will become apparent from the following detailed description of the invention.

### DETAILED DESCRIPTION OF THE INVENTION

The present invention provides a nutritious soy-based composition useful as supplementary food, the composition comprising about 41 to about 53% by dry weight wheat, about 5 to about 20% by dry weight malted Jowar flour, about 10 to about 20% by dry weight de-fatted soy flour (i.e., soya flour), about 5 to about 10% by dry weight roasted Bengal gram dhal and about 25 to about 35% sweetener. As used in the specification and claims, the terms soy and soya can be used interchangeably. Here and in all numerical values in the specification and claims, the limits of the ranges may be combined.

In an another embodiment of the present invention, the composition further comprises a minor quantity of a vitamin premix and a mineral premix.

In another embodiment of the present invention, the sweetener is selected from concentrated cane juice, white sugar, jaggery or their equivalents.

In yet another embodiment of the present invention, the vitamin premix comprises:

| | |
|---|---|
| Vitamin A (max.) | about 0.3 to about 0.35 mg |
| Vitamin D (max.) | about 200 to about 250 I.U. |
| Vitamin E (tocopherols) (min.) | about 30 to about 35 mg |
| Vitamin C (ascorbic acid) (min.) | about 30 to about 40 mg |
| Vitamin B₁ (thiamine as | about 0.6 to about 0.8 mg |
| hydrochloride) (min.) | |
| Vitamin B₂ (riboflavin) (min.) | about 0.7 to about 0.9 mg |
| Nicotinic acid (min.) | about 8 to about 10 mg |
| Folic acid (min.) | about 50 to about 60 μg |
| Vitamin B₆ (pyridoxine) (min.) | about 1.0 to about 1.2 mg |
| Biotin (min.) | about 0.15 to about 0.20 mg |
| Vitamin B₁₂ (min.) | about 0.0005 to about 0.0008 mg |
| Pantothenic acid (min.) | about 0.0025 to about 0.0030 mg. |

In still another embodiment of the present invention, the mineral mix comprises:

| | |
|---|---|
| Calcium (min.) | about 400 to about 450 mg |
| Iron (min.) | about 12 to about 15 mg |
| Phosphorus (min.) | about 500 to about 530 mg |
| Iodine (min.) | about 0.075 to about 0.080 mg |
| Magnesium (min.) | about 200 to about 220 mg |
| Zinc (min.) | about 7.5 to about 8.0 mg |
| Copper (min.) | about 1.0 to about 1.2 mg. |

In one more embodiment of the present invention, the composition provides about 350 to about 400 kcal per 100 grams.

In one another embodiment of the present invention, the composition provides proteins in excess of about 15%.

In a further embodiment of the present invention, the source of protein are as follows:

| | |
|---|---|
| Wheat Protein | about 4.32 to about 4.8% |
| Soy Protein | about 7.2 to about 7.5% |
| Bengal Gram Protein | about 2.4 to about 2.8% |
| Jowar/Pearl Millet Protein | about 0.64 to about 0.96% |

In another embodiment of the present invention, the composition is in the form of powder.

In another embodiment of the present invention, the powders pass through a 60 mesh sieve.

The present invention also provides a process for preparing a synergistic soy-based composition useful as supplementary food, the process comprising the step of mixing the below-mentioned ingredients in the respective quantum using an entoleter to have the uniform mixing of solids:

| | (Percent dry weight basis) |
|---|---|
| Major Ingredients | |
| Wheat | about 41 to about 53% |
| Malted Jowar Flour | about 5 to about 20% |
| De-fatted Soy Flour | about 10 to about 20% |
| Roasted Bengal Gram Dhal | about 5 to about 10% |
| Sweetener¹ | about 25 to about 35% |
| Minor Ingredients | |
| Vitamin Premix* to meet the requirements: | |
| Vitamin A (max.) | about 0.3 mg |
| Vitamin D (max.) | about 200 I.U. |
| Vitamin E (tocopherols) (min.) | about 30 mg |
| Vitamin C (ascorbic acid) (min.) | about 30 mg |
| Vitamin B₁ (thiamine as | about 0.6 mg |
| hydrochloride) (min.) | |
| Vitamin B₂ (riboflavin) (min.) | about 0.7 mg |
| Nicotinic acid (min.) | about 8 mg |
| Folic acid (min.) | about 50 μg |
| Vitamin B₆ (pyridoxine) (min.) | about 1.0 mg |
| Biotin (min.) | about 0.15 mg |
| Vitamin B₁₂ (min.) | about 0.0005 mg |
| Pantothenic acid (min.) | about 0.0025 mg |
| Minerals Premix* | |
| Calcium (min.) | about 400 mg |
| Iron (min.) | about 15 mg |
| Phosphorus (min.) | about 500 mg |
| Iodine (min.) | about 0.075 mg |
| Magnesium (min.) | about 200 mg |
| Zinc (min.) | about 7.5 mg |
| Copper (min.) | about 1.0 mg |

¹Concentrated Cane Juice could be either white sugar, jaggery or any equivalent thereof.
*quantities per manufacturers' daily prescribed consumption.

In one embodiment of the present invention, an improved process for the preparation of a nutritious soy-based formulation useful as a supplementary food with about 12 to about 15% protein and about 350 to about 400 kcal per 100 gram serving and comprises the stages (or steps) of:

(a) mixing roasted wheat flour having at least about 11% protein, malted Jowar flour, de-fatted soy flour, Bengal gram dhal flour, sweetener, vitamin premix. In order to optimize the raw material inputs viz.

(i) roasted wheat flour (X₁), de-fatted and toasted soy flour (X₂), malted Jowar flour (X₃), roasted Bengal gram flour (X₄), cane sugar (X₅) and vitamin and mineral premix (X₆), and

(ii) X₁, X₂, X₃, X₄, X₅ and X₆

the function, 0.5X₁+0.067X₂+0.067X₃+0.045X₄+0.312X₅+0.009X₆ was optimized using linear programming techniques.

The following constraints were taken into account:

0.012X₁+0.048X₂+0.08X₃+0.24X₄≧15.0 (protein)

3.46X₁+3.26X₂+4.32X₃+3.60X₄+3.83X₅≧360 (kcal)

X₁+X₂+X₃+X₄+X₅+X₆=101 (total parts)

X₅≧27

X₆=1

The optimum blend has the following composition:

Protein≧15

Calories≧360;

(b) malting of millets, like Jowar, may be carried out to increase the bio-availability of nutrients. The malted flour is amylase-rich whose indigenous action increases bio-availability of nutrients;

(c) roasting of the wheat is done separately using a fluidized bread roaster in the range of about 200 to about 260° C. until a light brown color was developed.

This is important for the flavor development and taste of the product;

(d) roasting of Bengal gram, powdering it and passing it through a 60 mesh sieve. Soy flour is toasted so that the trypsin inhibitor content comes to about one-third of its original value; and

(e) powdering the sweetener and passing it through a 60 mesh sieve.

In another embodiment of the process, the respective quantities of wheat, malted Jowar and de-fatted soy flour are by weight of ingredients:

| | |
|---|---|
| Wheat Protein | about 4.32 to about 4.8% |
| Soy Protein | about 7.2 to about 7.5% |
| Bengal Gram Protein | about 2.4 to about 2.8% |
| Jowar or Pearl Millet Protein | about 0.64 to about 0.96% |

In yet another embodiment of the process, the final formulation has a moisture content of about 4 to about 6%.

In yet another embodiment of the formulation, the final product has a protein content of about 12 to about 17%, or even about 12 to about 15%, and will provide a minimum of about 360 kcal energy per 100 grams.

In yet another embodiment of the process, the product has a minimum of about 2% fat and about 55% carbohydrate in the product.

In yet another embodiment of the final formulation, the product is highly acceptable with respect to color, appearance, taste and overall energy.

In yet another embodiment of the process, the final product has a 60 mesh particle size.

In another embodiment of the present invention, roasting of oil seed flour may be carried out at about 200° C. for flavor development, reduction of trypsin inhibitor content and reduction in moisture content.

In yet another embodiment of the present invention unrefined sugar/refined sugar in the range of about 25 to about 35% is powdered and added.

In still another embodiment of the process, mixing together of all dry ingredients through an entoleter ensures uniform mixing and sterility and the process comprises the following steps:

(1) roasting of wheat and Bengal gram is done separately using a Fluidized Bed Roaster at a temperature of about 180 to about 220° C. until a light brown color is developed. This is important for the flavor development and taste of the product. This step also helps in bringing down the moisture to the required levels and to prevent rancidity and softness of the product during storage;

(2) malting of Jowar is to improve the bio-availability of nutrients by the action of indigenous enzymes. This brings down the viscosity of the gruel. Sieving of dehydration and powdering of the millet removes the hull which is rich in anti-nutritional factors; and

(3) mixing together of the following ingredients:

| Major ingredients | |
|---|---|
| Wheat | about 41 to about 53% |
| Malted Jowar Flour | about 5 to about 20% |
| De-fatted Soy Flour | about 10 to about 20% |
| Soy Dhal | about 5 to about 10% |
| Roasted Bengal Gram Dhal | about 5 to about 10% |
| Sweetener¹ | about 25 to about 35% |
| Minor Ingredients | |
| Vitamin Premix* to meet the requirements: | |
| Vitamin A (max.) | about 0.3 mg |
| Vitamin D (max.) | about 200 I.U. |
| Vitamin E (tocopherols) (min.) | about 30 mg |
| Vitamin C (ascorbic acid) (min.) | about 30 mg |
| Vitamin B₁ (thiamine as | about 0.6 mg |
| hydrochloride) (min.) | |
| Vitamin B₂ (riboflavin) (min.) | about 0.7 mg |
| Nicotinic acid (min.) | about 8 mg |
| Folic acid (min.) | about 50 μg |
| Vitamin B₆ (pyridoxine) (min.) | about 1.0 mg |
| Biotin (min.) | about 0.15 mg |
| Vitamin B₁₂ (min.) | about 0.0005 mg |
| Pantothenic acid (min.) | about 0.0025 mg |
| Minerals Premix* | |
| Calcium (min.) | about 400 mg |
| Iron (min.) | about 15 mg |
| Phosphorus (min.) | about 500 mg |
| Iodine (min.) | about 0.075 mg |
| Magnesium (min.) | about 200 mg |
| Zinc (min.) | about 7.5 mg |
| Copper (min.) | about 1.0 mg |

¹Concentrated Cane Juice could be white sugar, jaggery or any equivalent thereof.
*quantities per manufacturers' daily prescribed consumption.

The initial stage of the mixing process comprises dry blending of ingredients through an entoleter. The entoleter allows the complete destruction of insects of all stages, thus resulting in sterilization of the flour by impact. These impacts are also useful for solid to solid mixing and excellent for on line homogenization of flour with micro-nutrients.

### Some Advantages of the Present Invention

Some advantages of the present invention lie in the fact that the present invention provides an improved process for preparation of nutritious soy-based formulation useful as supplementary food.

(1) Novelty of the formulation and process is that composition ensures a minimum of about 12 to about 17%, or even about 12 to about 15% protein of high quality.

(2) The final product will provide a minimum of about 360 kcal of energy per 100 grams.

(3) The formulation contains malted millets, like Jowar or pearl millet, which thereby increases the bioavailability of the nutrients and reduction in the viscosity of the final product.

(4) The roasting of wheat and Bengal gram in a fluidized bed drier ensures development of pleasing flavor and appealing color, thereby increasing palatability.

(5) Passing the formulation through an entoleter ensures microbial safety of the product and also helps to homogenize and mix major and minor ingredients through impact.

(6) The formulation gives a ready-to-eat product with at least 6 months shelf life.

The process is further illustrated by the examples given below. The Examples should not be construed to limit the scope of the invention.

### EXAMPLE 1

Example 1

| | | |
|---|---|---|
| Roasted wheat flour | 4.0 | kg |
| Malted Jowar flour | 0.8 | kg |
| De-fatted and toasted soy flour | 1.5 | kg |
| Roasted Bengal gram flour | 1.0 | kg |
| Cane sugar | 2.7 | kg |
| Calcium carbonate (CaCO₃) | 0.086 | kg |
| Ferrous sulfate (FeSO₄) | 0.009 | kg |
| Vitamin premix* | 0.0086 | kg |

Energy food of about 10.1 kg is obtained from mixing the above ingredients.

| Vitamin Premix* to meet the requirements: | | |
|---|---|---|
| Vitamin A (max.) | 0.3 | mg |
| Vitamin D (max.) | 200 | I.U. |
| Vitamin E (tocopherols) (min.) | 30 | mg |
| Vitamin C (ascorbic acid) (min.) | 30 | mg |
| Vitamin B₁ (thiamine as hydrochloride) (min.) | 0.6 | mg |
| Vitamin B₂ (riboflavin) (min.) | 0.7 | mg |
| Nicotinic acid (min.) | 8 | mg |
| Folic acid (min.) | 50 | μg |
| Vitamin B₆ (pyridoxine) (min.) | 1.0 | mg |
| Biotin (min.) | 0.15 | mg |
| Vitamin B₁₂ (min.) | 0.0005 | mg |
| Pantothenic acid (min.) | 0.0025 | mg |
| Minerals Premix* | | |
| Calcium (min.) | 400 | mg |
| Iron (min.) | 15 | mg |
| Phosphorus (min.) | 500 | mg |
| Iodine (min.) | 0.075 | mg |
| Magnesium (min.) | 200 | mg |
| Zinc (min.) | 7.5 | mg |
| Copper (min.) | 1.0 | mg |

*quantities per manufacturers' daily prescribed consumption.

Roasting of the wheat and Bengal gram is done separately using a Fluidized Bed Roaster at a temperature of about 180 to about 220° C. until a light brown color develops. This is important for the flavor development and taste of the product. Roasting the Bengal gram, powdering it and passing it through a 60 mesh sieve. Soy flour which has been toasted so that the trypsin inhibitor content comes to about one-third of its original value. The mixing together of all dry ingredients through an entoleter ensures uniform mixing and sterility. The final formulation has a moisture content of about 4 to about 6%, a protein content of about 12 to about 15%, a minimum of about 2% fat and about 55% carbohydrate in the product. The product will provide a minimum of about 360 kcal energy per 100 gram serving. The product has a shelf life of at least about 6 months.

### EXAMPLE 2

150 kg of base material from soy was mixed with 120 kg of malted Jowar flour, 100 kg of Bengal gram flour and 360 kg of the wheat flour, prepared by the unit operations of cleaning, de-stoning, roasting, grinding, cooling, etc., 270 kg of the powdered cane sugar prepared by the unit operations of cleaning and milling, to the above mixture, along with 0.86 kg vitamin premix, 8.6 kg calcium carbonate, 0.9 kg ferrous sulphate, was added to the above mixture by mixing in an efficient impact mill entoleter to give about 1010 kg of the energy food.

### EXAMPLE 3

15 kg of base material from soy was mixed with 10 kg of Bengal gram flour, 10 kg of malted Jowar flour and 38 kg of the wheat flour, prepared by the unit operations of cleaning, de-stoning, roasting, grinding, cooling, etc., 27 kg of the powdered cane sugar prepared by the unit operations of cleaning and milling, to the above mixture, along with 0.086 kg vitamin premix, 0.86 kg calcium carbonate, 0.09 kg ferrous sulphate, was added to the above mixture by mixing in an efficient impact mill entoleter to give about 101 kg of the energy food.

### Further Advantages of the Present Invention

(1) The soy-based supplementary food has high energy saving and product uniformity.

(2) The addition of amylase-rich flour ensures increase in the bio-availability of nutrients in the formulation.

(3) Toasted de-fatted soy flour addition is economical and provides calories with reduced amounts of anti-nutritional factors like trypsin inhibitors.

(4) The vitamin and mineral premix incorporated improves the nutritional value of the formulation significantly without increasing the calories. The formulation is enriched with vitamins, calcium, iron, phosphorus, copper, zinc, magnesium and iodine.

(5) The roasting of wheat and soy using fluidized bed dryer improves the flavor and color of the formulation improving its palatability.

(6) The step of entoleter treatment ensures microbial safety of the formulation as well as uniform mixing and homogenization of major and minor ingredients.

(7) A simple process in the form of ready-to-use by mixing or combining with water or milk to porridge/ball for consumption.

(8) The supplementary food based on cereals, legumes and oil seed flour and a sweetener (Jaggery/Cane sugar/Khandsari sugar).

(9) The food enriched with protein, calories, vitamins and minerals can be used for community feeding of children, pregnant women and lactating mothers to overcome the malnutrition.

(10) The process involved in the preparation destroys the infestation and anti-nutritional factors/improves the flavor and digestibility.

(11) The process steps lend themselves to easy scale up.

(12) The formulation can be used for mass feed in rural areas.

1. A nutritious soy-based composition useful as supplementary food, the composition comprising about 41 to about 53% by dry weight wheat, about 5 to about 20% by dry weight malted Jowar flour, about 10 to about 20% by dry weight de-fatted soy flour, about 5 to about 10% by dry weight roasted Bengal gram dhal and about 25 to about 35% sweetener.

2. A nutritious soy-based composition as claimed in claim 1, wherein the composition further comprises a minor quantity of a vitamin premix and a mineral premix.

3. A nutritious soy-based composition as claimed in claim 1, wherein the sweetener is selected from concentrated cane juice, white sugar, jaggery or equivalents thereof.

4. A nutritious soy-based composition as claimed in claim 2, wherein the vitamin premix comprises:

| | |
|---|---|
| Vitamin A (max.) | about 0.3 to about 0.35 mg |
| Vitamin D (max.) | about 200 to about 250 I.U. |
| Vitamin E (tocopherols) (min.) | about 30 to about 35 mg |
| Vitamin C (ascorbic acid) (min.) | about 30 to about 40 mg |
| Vitamin B₁ (thiamine as | about 0.6 to about 0.8 mg |
| hydrochloride) (min.) | |
| Vitamin B₂ (riboflavin) (min.) | about 0.7 to about 0.9 mg |
| Nicotinic acid (min.) | about 8 to about 10 mg |
| Folic acid (min.) | about 50 to about 60 μg |
| Vitamin B₆ (pyridoxine) (min.) | about 1.0 to about 1.2 mg |
| Biotin (min.) | about 0.15 to about 0.20 mg |
| Vitamin B₁₂ (min.) | about 0.0005 to about 0.0008 mg |
| Pantothenic acid (min.) | about 0.0025 to about 0.0030 mg. |

5. A nutritious soy-based composition as claimed in claim 2, wherein the mineral mix comprises:

| | |
|---|---|
| Calcium (min.) | about 400 to about 450 mg |
| Iron (min.) | about 12 to about 15 mg |
| Phosphorus (min.) | about 500 to about 530 mg |
| Iodine (min.) | about 0.075 to about 0.080 mg |
| Magnesium (min.) | about 200 to about 220 mg |
| Zinc (min.) | about 7.5 to about 8.0 mg |
| Copper (min.) | about 1.0 to about 1.2 mg. |

6. A nutritious soy-based composition as claimed in claim 1, wherein the composition provides about 350 to about 400 kcal per 100 grams.

7. A nutritious soy-based composition as claimed in claim 1, wherein the composition provides proteins in excess of about 15%.

8. A nutritious soy-based composition as claimed in claim 7, wherein the source of protein are as follows:

| | |
|---|---|
| Wheat Protein | about 4.32 to about 4.8% |
| Soy Protein | about 7.2 to about 7.5% |
| Bengal Gram Protein | about 2.4 to about 2.8% |
| Jowar/Pearl Millet Protein | about 0.64 to about 0.96%. |

9. A nutritious soy-based composition as claimed in claim 1, wherein the composition is in the form of powder.

10. A nutritious soy-based composition as claimed in claim 9, wherein the powders pass through a 60 mesh sieve.

11. A process for preparing a synergistic nutritious soy-based composition useful as supplementary food, the process comprising the steps of:
(a) roasting wheat flour and Bengal gram flour;
(b) toasting soy flour to reduce trypsin inhibitor content and malting pearl millet to increase bio-availability; and
(c) mixing about 41 to about 53% by dry weight roasted wheat flour, about 10 to about 20% by dry weight de-fatted soy flour, about 5 to about 20% by dry weight malted pearl millet, about 5 to about 10% by dry weight roasted Bengal gram flour and about 25 to about 35% by dry weight and a sweetener to obtain the synergistic nutritious soy-based composition useful as supplementary food.

12. A process as claimed in claim 11 wherein in step (a), the wheat flour and Bengal gram flour are roasted at a temperature in the range of about 200 to about 260° C.

13. A process as claimed in claim 12, wherein the wheat flour and Bengal gram flour are roasted in a fluidized bed roaster.

14. A process as claimed in claim 11 wherein in step (b), the soy flour is toasted at a temperature in the range of about 180 to about 220° C.

15. A process as claimed in claim 11 wherein in step (c), the ingredients are mixed using an entoleter.

16. A process as claimed in claim 11, wherein the sweetener used is selected from concentrated cane juice, white sugar, jaggery or equivalents thereof

17. A process as claimed in claim 11, wherein the synergistic nutritious soy-based composition thus obtained is in the form of a powder.

18. A process as claimed in claim 11, wherein the vitamin source comprises a vitamin premix.

19. A process as claimed in claim 18, wherein the vitamin premix comprises:

| | |
|---|---|
| Vitamin A (max.) | about 0.3 to about 0.35 mg |
| Vitamin D (max.) | about 200 to about 250 I.U. |
| Vitamin E (tocopherols) (min.) | about 30 to about 35 mg |
| Vitamin C (ascorbic acid) (min.) | about 30 to about 40 mg |
| Vitamin B₁ (thiamine as | about 0.6 to about 0.8 mg |
| hydrochloride) (min.) | |
| Vitamin B₂ (riboflavin) (min.) | about 0.7 to about 0.9 mg |
| Nicotinic acid (min.) | about 8 to about 10 mg |
| Folic acid (min.) | about 50 to about 60 μg |
| Vitamin B₆ (pyridoxine) (min.) | about 1.0 to about 1.2 mg |
| Biotin (min.) | about 0.15 to about 2.20 mg |
| Vitamin B₁₂ (min.) | about 0.0005 to about 0.0008 mg |
| Pantothenic acid (min.) | about 0.0025 to about 0.0030 mg. |

20. A process as claimed in claim 11, wherein the mineral source comprises a mineral premix.

21. A process as claimed in claim 20, wherein the mineral premix comprises:

| | |
|---|---|
| Calcium (min.) | about 400 to about 450 mg |
| Iron (min.) | about 12 to about 15 mg |
| Phosphorus (min.) | about 500 to about 530 mg |
| Iodine (min.) | about 0.075 to about 0.080 mg |
| Magnesium (min.) | about 200 to about 220 mg |
| Zinc (min.) | about 7.5 to about 8.0 mg |
| Copper (min.) | about 1.0 to about 1.2 mg. |

22. A process as claimed in claim 11, wherein the synergistic nutritious soy-based composition thus obtained contains about 12 to about 15% protein.

23. A process as claimed in claim 11, wherein 100 grams of the synergistic nutritious soy-based composition thus obtained provides about 350 to about 400 kcal of energy.
